(19) United States
(12) Patent Application Publication
(10) Pub. No.: US 2026/0060310 A1
(43) Pub. Date: Mar. 5, 2026

(54) HEATER ASSEMBLY AND AEROSOL GENERATING DEVICE INCLUDING THE SAME

(71) Applicant: KT&G CORPORATION, Daejeon (KR)

(72) Inventors: Se Hwan Jung, Anyang-si (KR); Gi Yun Kim, Osan-si (KR); Seung Peel Yim, Seoul (KR); Sang Joon Kim, Yongin-si (KR); Sang Kyu Park, Seoul (KR); Jae Min Lee, Siheung-si (KR)

(73) Assignee: KT&G CORPORATION, Daejeon (KR)

(21) Appl. No.: 19/266,544

(22) Filed: Jul. 11, 2025

(30) Foreign Application Priority Data
Sep. 2, 2024 (KR) 10-2024-0118799
Dec. 16, 2024 (KR) 10-2024-0187473

(51) Int. Cl. A24F 40/465; A24F 40/20; A24F 40/51; A24F 40/53; H05B 6/10; H05B 6/36

(52) U.S. Cl. CPC A24F 40/465; A24F 40/20; A24F 40/51; A24F 40/53; H05B 6/105; H05B 6/36

(57) ABSTRACT

A heater assembly for an aerosol generating device includes a cover housing, and a coil assembly inserted into the cover housing, wherein the coil assembly includes a coil configured to generate an alternating magnetic field when power is supplied, a first bracket including a receiving space for accommodating the coil and supporting the coil accommodated in the receiving space, a second bracket coupled to one end of the first bracket and supporting the coil, and a shielding member arranged to surround side surfaces of the first bracket and the coil and configured to shield a magnetic field radiating from the coil to an outside of the heater assembly, wherein the first bracket and the second bracket fix the shielding member.

### CROSS-REFERENCE TO RELATED APPLICATION

This application is based on and claims priority under 35 U.S.C. § 119 to Korean Patent Application Nos. 10-2024-0118799, filed on Sep. 2, 2024, and 10-2024-0187473, filed on Dec. 16, 2024, in the Korean Intellectual Property Office, the disclosures of which are incorporated by reference herein in their entirety.

### BACKGROUND

### 1. Field

Embodiments relate to a heater assembly in which components for heating an aerosol by using an induction heating method are modularized to increase the convenience of coupling, and the components may be stably supported, and an aerosol generating device including the heater assembly.

### 2. Description of the Related Art

Recently, the demand for alternative methods that overcome the shortcomings of general cigarettes has increased. For example, the demand for a system that generates an aerosol by heating a cigarette (or an ‘aerosol generating article’) using an aerosol generating device, rather than a method of generating an aerosol by burning a cigarette, has increased.

Existing aerosol generating devices generally generate an aerosol by using a resistance heating method, that is, by arranging a heater formed of an electric resistor inside or outside a cigarette and supplying power to the heater to heat the cigarette, but recently, various heating methods different from the resistance heating method have been proposed.

For example, an aerosol generating device using an induction heating method that heats a cigarette by utilizing a susceptor that generates heat by using an alternating magnetic field has been proposed. In the case of an aerosol generating device using an induction heating method, additional components, such as a coil for generating a magnetic field and a shielding member for preventing external leakage of the magnetic field, are required. Therefore, as the components are added compared to existing aerosol generating devices, the need for a method that can simplify a manufacturing process while firmly coupling the components together has arisen.

### SUMMARY

Because an aerosol generating device using an induction heating method requires additional components, such as a coil and a shielding member, compared to existing aerosol generating devices using a resistance heating method, it may take a lot of time to assemble the components during a manufacturing process, and a heating performance may deteriorate due to deviation (or ‘assembly deviation’) occurring during an assembly process.

For example, when the coil deviates from a pre-designed position due to deviation occurring during the assembly process, a magnetic field may not be radiated as intended, which may deteriorate an overall heating efficiency of the aerosol generating device, resulting in a situation in which the amount of aerosols generated and a user's smoking sensation deteriorate. In addition, when the shielding member deviates from a pre-designed position due to deviation occurring during the assembly process, the magnetic field generated from the coil may leak to the outside of the aerosol generating device, which may cause interference between the aerosol generating device and an external electronic device.

Accordingly, various embodiments provide a heater assembly in which components, such as a coil for heating a cigarette by using an induction heating method and a shielding member, are modularized, and an aerosol generating device including the heater assembly, thereby simplifying an assembly process of the aerosol generating device and strengthening coupling of the components to prevent an induction heating performance from deteriorating due to an assembly deviation.

The technical problems of the present disclosure are not limited to the above-described description, and other technical problems may be clearly understood by one of ordinary skill in the art from the embodiments to be described hereinafter.

Additional aspects will be set forth in part in the description which follows and, in part, will be apparent from the description, or may be learned by practice of the presented embodiments of the disclosure.

A heater assembly for an aerosol generating device according to an embodiment may include a cover housing, and a coil assembly inserted into the cover housing, wherein the coil assembly may include a coil configured to generate an alternating magnetic field when power is supplied, a first bracket including a receiving space for accommodating the coil and supporting the coil accommodated in the receiving space, a second bracket coupled to one end of the first bracket and supporting the coil, and a shielding member arranged to surround side surfaces of the first bracket and the coil and configured to shield a magnetic field radiating from the coil to an outside of the heater assembly, wherein the first bracket and the second bracket may fix the shielding member.

An aerosol generating device according to an embodiment may include a heater assembly including a cover housing and a coil assembly inserted into the cover housing, and a housing accommodating the heater assembly, wherein the coil assembly may include a coil configured to generate an alternating magnetic field when power is supplied, a first bracket including a receiving space for accommodating the coil and supporting the coil accommodated in the receiving space, a second bracket coupled to one end of the first bracket and supporting the coil, and a shielding member arranged to surround side surfaces of the first bracket and the coil and configured to shield a magnetic field radiating from the coil to an outside of the heater assembly, and the cover housing may include a receiving portion into which at least a portion of an aerosol generating article is inserted, and a susceptor arranged inside the receiving portion so as to be insertable into the aerosol generating article and configured to heat the aerosol generating article by generating heat by using an alternating magnetic field generated by the coil, wherein the first bracket and the second bracket may fix the shielding member.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2A illustrates an aerosol generating device according to an embodiment;

FIG. 2B illustrates an aerosol generating device according to an embodiment;

FIG. 3 is a perspective view of an aerosol generating device according to an embodiment;

FIG. 4 is an exploded perspective view of the aerosol generating device of FIG. 3;

FIG. 5 is a perspective view of a coil assembly of an aerosol generating device according to an embodiment;

FIG. 6 is an exploded perspective view of the coil assembly of FIG. 5; and

FIG. 7 is a cross-sectional view of an aerosol generating device according to an embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Various embodiments of the present disclosure may be implemented as software including one or more instructions stored in a storage medium (e.g., a memory 17) readable by a machine (e.g., an aerosol generating device 1). For example, a processor (e.g., a controller 12) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

In the present disclosure, a direction of the aerosol generating device 1 may be defined based on an orthogonal coordinate system. The x-axis direction in the orthogonal coordinate system may be defined as a left-right direction of the aerosol generating device 1. The y-axis direction may be defined as a front-back direction of the aerosol generating device 1. The z-axis direction may be defined as an upward and downward direction of the aerosol generating device 1.

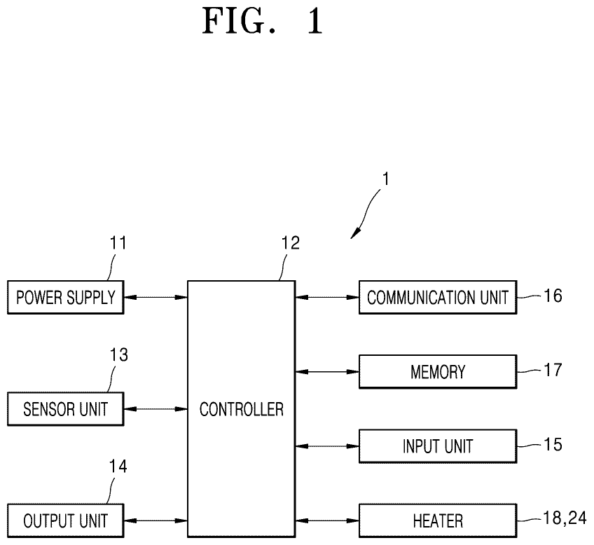

FIG. 1 is a block diagram of the aerosol generating device 1 according to an embodiment.

According to an embodiment, the aerosol generating device 1 may include a power supply 11, the controller 12, a sensor unit 13, an output unit 14, an input unit 15, a communication unit 16, a memory 17, and/or heater 18 or 24. However, it may be understood by those skilled in the art that some of the components shown in FIG. 1 may be omitted or new components may be added, according to the design of the aerosol generating device 1.

According to an embodiment, the sensor unit 13 may sense a state of the aerosol generating device 1 or a state of the surroundings of the aerosol generating device 1 and may transmit information corresponding to the sensed state to the controller 12. For example, the sensor unit 13 may include a temperature sensor, a puff sensor, an insertion detection sensor, a reuse detection sensor, an overwetting detection sensor, a cigarette identification sensor, a cartridge detection sensor, a cap detection sensor, and/or a movement detection sensor. The sensor unit 13 may further include various sensors, such as a liquid remaining amount sensor for detecting the liquid remaining amount of a cartridge and an immersion sensor for detecting immersion of the aerosol generating device 1.

According to an embodiment, the temperature sensor may detect the heating temperature of the heater 18 or 24 The aerosol generating device 1 may include a separate temperature sensor for detecting respective temperatures of the heater 18 or 24, or the heater 18 or 24 may serve as a temperature sensor. For example, the temperature sensor may be used to measure an impedance of the heater 18. The impedance of the heater 18 may be correlated with the temperature of the heater 18. The temperature sensor may measure a current and/or voltage applied to the heater 18 (or an induction coil). Based on the measured current and/or voltage, the impedance for the heater 18 may be calculated. The controller 12 may estimate the temperature of the heater 18, based on the calculated impedance.

For example, the temperature sensor may include a resistive element (e.g., a thermistor) whose resistance value changes in response to a change in temperatures of the heater 18 or 24. The temperature sensor may output a signal corresponding to the resistance value of the resistive element, and the controller 12 may detect the temperatures and/or temperature changes of the heater 18 or 24, based on the signal corresponding to the resistance value.

As another example, the temperature sensor may include a sensor for detecting the resistance values of the heater 18 or 24. The temperature sensor may output signals corresponding to the resistance values of the heater 18 or 24, and the controller 12 may detect the temperatures and/or temperature changes of the heater 18 or 24, based on the signals corresponding to the resistance values.

According to an embodiment, the temperature sensor may detect a temperature of the power supply 11. The temperature sensor may be disposed adjacent to the power supply 11. For example, the temperature sensor may be attached to one surface of the power supply 11 (e.g., a battery) and/or mounted on one surface of a printed circuit board. For example, the aerosol generating device 1 may include a power protection circuit module (PCM), and the temperature sensor may be disposed adjacent to the power supply 11 together with the power PCM.

According to an embodiment, the temperature sensor may be disposed inside a housing (not shown) of the aerosol generating device 1 to detect an internal temperature of the housing.

According to an embodiment, the puff sensor may detect a puff of a user.

For example, the puff sensor may include a pressure sensor. The pressure sensor may output a signal corresponding to an internal pressure of the aerosol generating device 1, and the controller 12 may detect the puff of the user, based on the signal corresponding to the internal pressure. The internal pressure of the aerosol generating device 1 may correspond to pressure of an airflow path along which gas flows. The puff sensor may be disposed to correspond to the airflow path along which gas flows, in the aerosol generating device 1.

As another example, the puff sensor may include a temperature sensor. When the user' puff occurs, a temporary temperature drop may occur in the airflow path, a space where an aerosol generating article is inserted (hereinafter, an insertion space), the heater 18 or 24, etc. The controller 12 may detect the user's puff, based on a signal corresponding to the temperature of the airflow path, etc. output from the temperature sensor.

As another example, the puff sensor may include both a pressure sensor and a temperature sensor. In this case, the temperature sensor may measure a temperature that is used to correct an internal pressure measured by the pressure sensor. For example, the puff sensor may correct the signal corresponding to the internal pressure, based on the temperature measured by the temperature sensor, and may output the corrected signal. As another example, the puff sensor may output the signal corresponding to the temperature measured by the temperature sensor, and the signal corresponding to the internal pressure measured by the puff sensor. In this case, the controller 12 may receive the signals, and may correct the signal corresponding to the internal pressure, based on the signal corresponding to the temperature.

As another example, the puff sensor may include a capacitance sensor. In the present disclosure, the capacitance sensor may also be referred to as a cap sensor or a capacitive sensor. When the user's puff occurs, a temperature change and/or aerosol flow may occur within the insertion space of the aerosol generating article, and accordingly, an internal permittivity of the insertion space may change. The controller 12 may detect the user's puff, based on a signal corresponding to the internal permittivity, etc. of the insertion space output by the temperature sensor.

The puff sensor is not limited to the aforementioned examples, and may be implemented using various sensors for detecting the user's puff.

According to an embodiment, the insertion detection sensor may detect insertion and/or removal of the aerosol generating article. The insertion detection sensor may be provided around the insertion space. The insertion detection sensor may also include any combination of the aforementioned examples.

For example, the insertion detection sensor may include a capacitance sensor. The capacitance sensor may include at least one conductor. The at least one conductor may be arranged adjacent to the insertion space. When the aerosol generating article is inserted into or removed from the insertion space, a permittivity around the conductor may change. The controller 12 may detect the insertion and/or removal of the aerosol generating article, based on a signal corresponding to the internal permittivity, etc. of the insertion space output by the capacitance sensor.

As another example, the insertion detection sensor may include an inductive sensor. The inductive sensor may include at least one coil. The at least one coil may be disposed adjacent to the insertion space. When the aerosol generating article (e.g., a wrapper of the aerosol-generating article) includes a conductor and is inserted into or removed from the insertion space, a change in a magnetic field may occur around a coil where a current flows. The controller 12 may detect insertion and/or removal of the aerosol generating article including the conductor, based on the characteristics (e.g., a frequency, a current value, a voltage value, an inductance value, and an impedance value of an alternating current) of a current output or detected by the inductive sensor. Alternatively, the aerosol generating article (e.g., a medium portion of the aerosol generating article) may include a susceptor (SUS), etc. Even in this case, a change in the magnetic field around the coil may occur based on the insertion or removal of the susceptor, etc. within the insertion space, and the controller 12 may also detect the insertion and/or removal of the aerosol generating article, based on the characteristics of the current of the inductive sensor.

The insertion detection sensor is not limited to the aforementioned examples, and may be implemented using any of various sensors (e.g., a proximity sensor) for detecting insertion and/or removal of the aerosol generating article. The insertion detection sensor may also include any combination of the aforementioned examples. According to an embodiment, the insertion detection sensor may include a switch, etc. for detecting compression performed by the aerosol generating article.

According to an embodiment, the reuse detection sensor may detect whether the aerosol generating article is reused For example, the reuse detection sensor may be a color sensor for detecting a color of the aerosol generating article. When the aerosol generating article is used by the user, a change in the color of a portion of the wrapper surrounding the outside of the aerosol generating article may occur due to generated aerosol or heating. The color sensor may output a signal corresponding to optical characteristics (e.g., a wavelength of light) corresponding to the color of the wrapper, based on light reflected by the wrapper. When a change in the color of the portion of the wrapper is detected, the controller 12 may determine that the aerosol generating article inserted into the insertion space has already been used.

According to an embodiment, the overwetting detection sensor may detect whether the aerosol generating article is in an overwetting state. For example, the overwetting detection sensor may include a capacitance sensor. The capacitance sensor may include at least one conductor disposed adjacent to the insertion space. The controller 12 may detect whether the aerosol generating article is in an overwetting state, based on the level of a signal corresponding to a permittivity, etc. output by the capacitance sensor. For example, the controller 12 may check a level range including the level of the signal, based on a look-up table, and may determine a moisture content for the aerosol generating article, based on the checked level range.

According to an embodiment, the cigarette identification sensor may detect whether the aerosol generating article is authentic, and/or detect the type of the aerosol generating article.

For example, the cigarette identification sensor may include an optical sensor for detecting an identification material (or an identification mark) located on an outer surface (e.g., a wrapper) of the aerosol generating article. The optical sensor may radiate light toward the identification material (or the identification mark) of the aerosol generating article, and may detect the authenticity and/or the type of the aerosol generating article, based on the reflected light. For example, the identification material may include a material that emits light of a wavelength in a specific band, based on the radiated light. The controller 12 may detect the authenticity and/or the type of the aerosol generating article, based on the range of the wavelength.

As another example, the cigarette identification sensor may include a capacitance sensor. According to the types of aerosol generating article inserted into the insertion space, the internal permittivity of the insertion space may vary. The controller 12 may detect he authenticity of and/or the type of the aerosol generating article, based on the signal corresponding to the internal permittivity, etc. of the insertion space output by the capacitance sensor.

As another example, the cigarette identification sensor may include an inductive sensor. When a conductor is included in the wrapper and/or interior (e.g., a medium portion) of the aerosol generating article inserted into the insertion space, the characteristics of a current detected by the inductive sensor (e.g., a frequency, a current value, a voltage value, an inductance value, and an impedance value of an AC current) may differ according to the types of aerosol generating article inserted into the insertion space. The controller 12 may detect he authenticity of and/or the type of the aerosol generating article, based on the characteristics of a current output by the capacitance sensor or detected by the inductive sensor.

The cigarette identification sensor is not limited to the aforementioned examples, and may be implemented using any of various sensors for detecting whether the aerosol generating article is authentic, and/or detecting the type of the aerosol generating article. The cigarette identification sensor may also include any combination of the aforementioned examples.

According to an embodiment, the cartridge detection sensor may detect insertion and/or removal of the cartridge. For example, the cartridge detection sensor may include an inductive sensor, a capacitance sensor, a resistance sensor, a hall sensor (a hall IC) using a hall effect, and/or an optical sensor.

According to an embodiment, the cap detection sensor may detect insertion and/or removal of the cap. For example, the cap detection sensor may include an inductive sensor, a capacitance sensor, a resistance sensor, a hall sensor (a hall IC), and/or an optical sensor. The cap may include a structure that covers at least a portion of the cartridge mounted on or inserted into the aerosol generating device 1 or covers at least a portion of the housing of the aerosol generating device 1. When the cap is mounted on or removed from the housing, the cap detection sensor may output a signal corresponding to the mounting or removal of the cap. The controller 12 may detect the mounting or removal of the cap, based on a signal corresponding to the mounting or removal.

According to an embodiment, the movement detection sensor may detect a motion of the aerosol generating device 1. The movement detection sensor may be implemented using at least one of an acceleration sensor and a gyro sensor.

According to an embodiment, the sensor unit 13 may further include at least one of a humidity sensor, a pressure sensor, a magnetic sensor, a global positioning sensor (GPS), or a proximity sensor, in addition to the above-described sensors. Functions of the sensors would be instinctively understood by one of ordinary skill in the art in view of their names and thus detailed descriptions thereof will be omitted herein.

According to an embodiment, the output unit 14 may output information about the state of the aerosol generating device 1. The output unit 14 may include a display, a haptic unit, and/or a sound output unit, but embodiments are not limited thereto. For example, information about the aerosol generating device 1 may include a charging/discharging state of the power supply 11 of the aerosol generating device 1, preheating states of the heater 18 or 24, an insertion/removal state of the aerosol generating article and/or the cartridge, a mounting and/or removal state of the cap, or a state in which use of the aerosol generating device 1 is limited (e.g., detection of an abnormal article). The display may visually provide the information about the state of the aerosol generating device 1 to the user. For example, the display may include a light-emitting diode (LED), a liquid crystal display (LCD), an organic light-emitting diode (OLED), etc. When the display includes a touch pad, the display may also be used as an input unit 15. A haptic unit may tactually provide the information about the state of the aerosol generating device 1 to the user. For example, the haptic unit may include a vibration motor, a piezoelectric element, an electrical stimulation device, etc. The sound output unit may acoustically provide the information about the aerosol generating device 1 to the user. For example, the sound output unit may convert an electrical signal into a sound signal and may output the sound signal to the outside.

According to an embodiment, the power supply 11 may output power for operating the aerosol generating device 1. The power supply 11 may include one or more batteries. The power supply 11 may supply power so that the heater 18 or 24 may be heated. In addition, the power supply 11 may supply power required for operations of the controller 12, the sensor unit 13, the output unit 14, the input unit 15, the communication unit 16, the memory 17, etc. which are other components included in the aerosol generating device 1. The power supply 11 may be a rechargeable battery or a disposable battery. For example, the power supply 11 may be a lithium polymer (LiPoly) battery, but embodiments are not limited thereto. The power supply 11 may be a rechargeable (separate-type) battery (hereinafter, a detachable battery. The detachable battery may be mounted on a battery accommodation part provided within the aerosol generating device 1, or may be removed from the battery accommodation part. The detachable battery may be charged either via wire or wirelessly.

According to an embodiment, the heater 18 or 24 may heat a medium and/or an aerosol generating material within the aerosol generating article and/or the cartridge by receiving power from the power supply 11. The aerosol generating device 1 may include a heater 18 for heating the aerosol generating article and/or a cartridge heater 24 for heating the cartridge (i.e., a solid and/or liquid medium).

According to an embodiment, the heater 18 or 24 may be electro-resistive heaters. For example, the electro-resistive heaters may include an electro-resistive material, such as a metal including titanium, zirconium, tantalum, platinum, nickel, cobalt, chromium, hafnium, niobium, molybdenum, tungsten, tin, gallium, manganese, iron, copper, stainless steel, nichrome, or the like, or a metal alloy. The electro-resistive heaters may be implemented using a metal heating wire, a metal heating plate on which an electric conductive track is disposed, a ceramic heating body, or the like.

According to an embodiment, the heater 18 or 24 may be induction heating heaters. For example, the induction heating heaters may include a susceptor that generates heat through a magnetic field. The magnetic field may be generated from an induction coil by an AC current flowing through the induction coil. The generated magnetic field may penetrates a heater and an eddy current may be generated by the susceptor. The susceptor may be heated based on the generation of the eddy current. According to an embodiment, the susceptor may be included within the aerosol generating article (e.g., the medium portion). Even in this case, the susceptor included within the aerosol generating article may be heated by the induction coil.

The heater 18 or 24 are not limited to the aforementioned examples, and may include or be replaced with various heating methods, structures, components, etc. for heating the aerosol generating article and/or the cartridge.

According to an embodiment, the input unit 15 may receive information input by the user. For example, the input unit 15 may include a touch panel, a button, a keypad, a dome switch, a jog wheel, a jog switch, etc.

According to an embodiment, the memory 17 is hardware for storing various kinds of data processed in the aerosol generating device 1, and may store pieces of data that have been processed and are to be processed by the controller 12. For example, the memory 17 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. For example, the memory 17 may store data about an operating time of the aerosol generating device 1, a maximum number of puffs, a current number of puffs, at least one temperature profile, and the user's smoking pattern.

According to an embodiment, the communication unit 16 may include at least one component for communication with another electronic device (e.g., a portable electronic apparatus). For example, the communication unit 16 may include a Bluetooth communication unit, a Bluetooth Low Energy (BLE) communication unit, an Near Field Communication (NFC) communication unit, a wireless local area network (WLAN) communication unit, a ZigBee communication unit, an infrared Data Association (IrDA) communication unit, a Wireless Fidelity Direct (WFD) communication unit, an ultra wideband (UWB) communication unit, an Adaptive Network Topology (Ant)+communication unit, a cellular network communication unit, an Internet communication unit, a computer network (e.g., a LAN or WAN) communication unit, etc.

According to an embodiment, the controller 12 may control overall operations of the aerosol generating device 1. For example, the controller 12 may include at least one processor. The controller 12 may be implemented as an array of a plurality of logic gates, or as a combination of a general-use micro controller unit (MCU) (or a microprocessor) and a memory in which a program executable by the general-use MCU is stored. It will also be understood by one of ordinary skill in the art to which the present embodiment pertains that the controller 12 may be implemented as other types of hardware.

According to an embodiment, the controller 12 may control supplying of the power of the power supply 11 to the heater 18 or 24, thereby controlling the temperatures of the heater 18 or 24. The controller 12 may control the temperatures of the heater 18 or 24 and/or power supplied to the heater 18 or 24, based on the temperatures of the heater 18 or 24 detected using the temperature sensor (e.g., the sensor unit 13). The controller 12 may control the temperatures of the heater 18 or 24 and/or the power supplied to the heater 18 or 24, based on a temperature profile and/or a power profile stored in the memory 17.

According to an embodiment, the controller 12 may control power (e.g., a voltage and/or a current) supplied to the heater 18 or 24 by controlling a power conversion circuit (not shown) electrically connected to the heater 18 or 24 and the power supply 11. For example, the power conversion circuit may include a DC/DC converter (e.g., a buck converter, a buck-boost converter, a boost converter, or a Zener diode) that converts power that is to be supplied to the heater 18 or 24, and a DC/AC converter (e.g., an inverter) that converts power that is to be supplied to an induction coil (not shown). The DC/AC inverter may be implemented as a full-bridge circuit or half-bridge circuit including a plurality of switching elements. For example, the power conversion circuit may include at least one switching element, such as a bipolar junction transistor (BJT) and a field effect transistor (FET).

According to an embodiment, the controller 12 may control the current and/or voltage supplied to the heater 18 or 24 by controlling the frequency and/or duty ratio of a current pulse input to the at least one switching element of the power conversion circuit. A duty ratio with respect to an on/off operation of the switching element may correspond to a ratio of an output voltage of the power conversion circuit to an output voltage of the power supply 11.

According to an embodiment, the controller 12 may control power that is supplied to the heater 18 or 24, by using at least one method among a pulse width modulation (PWM) method and a proportional-integral-differential (PID) method. For example, the controller 12 may control a current pulse having a certain frequency and a duty ratio to be supplied to the heater 18 or 24, by using the PWM method. The controller 12 may control the power supplied to the heater 18 or 24, by adjusting the frequency and duty ratio of the current pulse. For example, the controller 12 may determine a target temperature that is a target of control, based on the temperature profile. The controller 12 may control the power supplied to the heater 18 or 24, by using a PID method, which is a feedback control method using a difference value between the temperatures of the heater 18 or 24 and the target temperature thereof, a value obtained by integrating the difference value according to the flow of time, and a value obtained by differentiating the difference value according to the flow of time.

According to an embodiment, the controller 12 may determine target power that is a target of control, based on the power profile. The controller 12 may control the power supplied to the heater 18 or 24 to correspond to preset target power, according to the flow of time.

According to an embodiment, the controller 12 may detect the user's puff by detecting the power supplied to the heater 18 or 24. In more detail, the controller 12 may control the power supplied to the heater 18 or 24, by using the PID method. When the user' puff occurs, a temporary temperature drop may occur in a space where the aerosol generating article is inserted (hereinafter, the insertion space), the heater 18 or 24, etc. Accordingly, a change may occur in the power (or current) supplied to the heater 18 or 24 during power control using the PID method. The controller 12 may detect the user's puff, based on a change in the power that is controlled.

According to an embodiment, the controller 12 may prevent the heater 18 or 24 from being heated. For example, the controller 12 may control an operation of the power conversion circuit so that the amount of the power supplied to the heater 18 or 24 is reduced or the power supply to the heater 18 or 24 is stopped, based on the temperatures of the heater 18 or 24 exceeding a preset limit temperature.

According to an embodiment, the controller 12 may control charging/discharging of the power supply 11. For example, the controller 12 may check the temperature of the power supply 11 by using the temperature sensor (e.g., the sensor unit 13). When the temperature of the power supply 11 is equal to or greater than a first limit temperature, the controller 12 may block charging of the power supply 11. When the temperature of the power supply 11 is greater than or equal to a second limit temperature, the controller 12 may stop using (e.g., discharging) the power stored in the power supply 11. The controller 12 may calculate the remaining capacity of the power stored in the power supply 11. For example, the controller 12 may calculate the remaining capacity of the power supply 11, based on a voltage and/or current sensing value of the power supply 11.

According to an embodiment, the controller 12 may control supply of power to the heater 18 or 24, based on a result of the sensing performed by the sensor 13.

According to an embodiment, the controller 12 may control supply of power to the heater 18 or 24, based on insertion and/or removal of the aerosol generating article into and/or the insertion space. For example, when it is determined using the insertion detection sensor (e.g., the sensor unit 13) that the aerosol generating article has been inserted into the insertion space, the controller 12 may control power to be supplied to the heater 18 or 24. When it is determined using the insertion detection sensor (e.g., the sensor unit 13) that the aerosol generating article has been removed from the insertion space, the controller 12 may block the supply of power to the heater 18 or 24. When the temperatures of the heater 18 or 24 are equal to or greater than a limit temperature or temperature change slopes of the heater 18 or 24 are equal to or greater than a set slope, the controller 12 may determine that the aerosol generating article has been removed from the insertion space.

According to an embodiment, the controller 12 may control power supply time periods and/or power supply amounts for the heater 18 or 24, based on the state of the aerosol generating article. For example, when it is determined using the overwetting detection sensor (e.g., the sensor unit 13) that the aerosol generating article is in an overwetting state, the controller 12 may increase the power supply time periods (e.g., preheating time periods) for the heater 18 or 24.

According to an embodiment, the controller 12 may control supply of power to the heater 18 or 24, based on reuse or non-reuse of the aerosol generating article. For example, when it is determined that the aerosol generating article has been used, the controller 12 may block supply of power to the heater 18 or 24.

According to an embodiment, the controller 12 may control supply of power to the heater 18 or 24, based on attachment and/or removal of the cartridge. For example, when it is determined using the cartridge detection sensor (e.g., the sensor unit 13) that the cartridge is in a separated state, the controller 12 may block supply of power to the heater 18 or 24 or may control power to be not supplied to the heater 18 or 24.

According to an embodiment, the controller 12 may control supply of power to the heater 18 or 24, based on whether the aerosol generating material of the cartridge has been exhausted. For example, when it is determined that the temperatures of the heater 18 or 24 exceed the limit temperature while the heater 18 or 24 are being preheated (i.e., in a preheating section), the controller 12 may determine that the aerosol generating material in the cartridge has been exhausted. When it is determined that the aerosol generating material of the cartridge has been exhausted, the controller 12 may cut off the supply of power to the heater 18 or 24.

According to an embodiment, the controller 12 may control the supply of power to the heater 18 or 24, based on whether use of the cartridge is possible. For example, when it is determined based on data stored in the memory 17 that a current number of puffs is equal to or greater than a maximum number of puffs set in the cartridge, the controller 12 may determine that the use of the cartridge is not possible. For example, when a total time period during which the heater 18 or 24 are heated is greater than or equal to a preset maximum time period or a total amount of power supplied to the heater 18 or 24 is greater than or equal to a preset maximum power amount, the controller 12 may determine that the use of the cartridge is not possible. In this case, the controller 12 may block supply of power to the heater 18 or 24 or may control power to be not supplied to the heater 18 or 24.

According to an embodiment, the controller 12 may control the supply of power to the heater 18 or 24, based on the user's puff. For example, the controller 12 may determine occurrence or non-occurrence of a puff and/or the intensity of the puff, by using the puff sensor (e.g., the sensor unit 13). When the number of puffs reaches the preset maximum of puffs or puffs are not sensed for a preset time period or more, the controller 12 may cut off the supply of power to the heater 18 or 24. When a puff is sensed, the controller 12 may control the supply of power to the heater 18 or 24.

According to an embodiment, the controller 12 may control supply of power to the heater 18 or 24, based on authenticity of the aerosol generating article (or the cartridge) and/or the type of the aerosol generating article. For example, the controller 12 may detect authenticity or of the aerosol generating article and/or the type of the aerosol generating article, by using the cigarette identification sensor (e.g., the sensor unit 13). For example, when the aerosol generating article (or the cartridge) is detected as counterfeit, the controller 12 may block supply of power to the heater 18 or 24. When the aerosol generating article (or the cartridge) is detected as authentic, the controller 12 may control (e.g., start) supply of power to the heater 18 or 24. As another example, the controller 12 may differently control power supply to the heater 18 or 24 according to the types of aerosol generating article (or cartridge). In more detail, when the aerosol generating article (or the cartridge) is detected as a first aerosol generating article (or a first cartridge), the controller 12 may control the temperatures and/or power of the heater 18 or 24, based on a first temperature profile (or a first power profile), and, when the aerosol generating article (or cartridge) is detected as a second aerosol generating article (or a second cartridge), may control the temperatures and/or power of the heater 18 or 24, based on a second temperature profile (or a second power profile).

According to an embodiment, the controller 12 may control the output unit 14, based on a result of the sensing performed by the sensor unit 13. For example, when the number of puffs counted using the puff sensor (e.g., the sensor unit 13) reaches a preset number, the controller 12 may control the output unit 14 to visually, tactually, and/or acoustically provide information indicating that the aerosol generating device 1 is about to be terminated. For example, the controller 12 may control the output unit 14 to visually, tactually, and/or acoustically provide information about the temperatures of the heater 18 or 24.

According to an embodiment, the controller 12 may store and update a history of an event occurred in the memory 17, based on certain event occurrence. For example, the event may include insertion detection of the aerosol generating article, heating start of the aerosol generating article, puff detection, puff end, overheat detection of the heater 18 or 24, detection of overvoltage application to the heater 18 or 24, heating end of the aerosol generating article, an operation such as power on/off of the aerosol generation device 1, charging start of the power supply 11, detection of overcharging of the power supply 11, and charging end of the power supply 11, which are performed by the aerosol generating device 1. For example, the history of the event may include, for example, a date and time of the event, and log data corresponding to the event. For example, when a predetermined event is insertion detection of the aerosol generating article, log data corresponding to the event may include data for a sensing value, etc. of the insertion detection sensor (e.g., the sensor unit 13). For example, when the predetermined event is overheating detection of the heater 18 or 24, the log data corresponding to the event may include data about, for example, the temperature of the heater 18 or 24, the voltage applied to the heater 18 or 24, and the current flowing through the heater 18 or 24.

According to an embodiment, the controller 12 may control the communication unit 16 to form a communication link with an external device, such as the user's mobile terminal.

According to an embodiment, when receiving data on authentication from the external device through the communication link, the controller 12 may dismiss limitation of the use of at least one function (e.g., a heating function) of the aerosol generating device 1. For example, the data on authentication may include the user's birthday, a unique number representing the user, and completion or non-completion of authentication of the user.

According to an embodiment, the controller 12 may transmit data on the state of the aerosol generating device 1 (e.g., a remaining capacity of the power supply 11, and an operating mode) to the external device via the communication link. The transmitted data may be output through, for example, a display of the external device.

According to an embodiment, when a request for a location search of the aerosol generating device 1 is received from the external device via the communication link, the controller 12 may control the communication unit 16 to perform an operation corresponding to the location search. For example, the controller 12 may control the haptic unit to generate vibration, or may control the display to output an object corresponding to the location search and a search end.

According to an embodiment, when receiving firmware data from the external device via the communication link, the controller 12 may perform firmware update.

According to an embodiment, the controller 12 may transmit data on a sensing value of at least one sensor unit 13 to an external server (not shown) through the communication link, and may receive and store a learning model generated by learning sensing values from a server through machine learning, such as deep learning. The controller 12 may perform, for example, an operation of determining the user's inhaling pattern and an operation of generating a temperature profile, by using the learning model received from the server.

Although not shown in FIG. 1, the aerosol generating device 1 may further include a power supply protection circuit. The power protection circuit may include at least one switching element, and may cut off transmission path to the power supply 11 in response to overcharging and/or overdischarging of the power supply 11. The aerosol generating device 1 may further include a connection interface, such as a universal serial bus (USB) interface, and may transmit/receive information by being connected to another external device through the connection interface, or may charge the power supply 11.

The aerosol generating article as described herein may include at least one aerosol generating rod (e.g., a medium portion) and at least one filter rod. The heater 18 may be arranged to correspond to the at least one aerosol generating rod, and may be designed differently according to arrangement orders and/or locations of the aerosol generating rod and the filter rod. The aerosol generating rod may include at least one of nicotine, an aerosol generating material, and additives. For example, the aerosol generating material may include glycerin (e.g., vegetable glycerin (VG)) and/or propylene glycol (PG), but may also include various other materials. For example, the additives may include flavors and/or organic acid, and may also include various other materials. For example, the aerosol generating rod may include an aerosol generating substrate (e.g., a sheet) impregnated with a liquid non-tobacco material (e.g., an aerosol generating material and/or nicotine), and/or may include a solid tobacco material (e.g., leaf tobacco and reconstituted tobacco). The tobacco material may be included in the aerosol generating rod in various forms, such as Cut Tobacco, granules, or powder. According to an embodiment, the additives of the aerosol generating rod may include an alkaline substance. Based on the basic material, the nicotine of the tobacco material included in the aerosol generating rod may have an alkaline pH (e.g., pH 7.0 or higher). In this case, freebase nicotine may be released from the aerosol generating rod even at low temperature. According to an embodiment, the aerosol generating rod may include two or more aerosol generating rods, wherein the two or more aerosol generating rods may include a tobacco material and/or a non-tobacco material, respectively. Although not shown, at least one aerosol generating rod and at least one filter rod may be individually and/or integrally wrapped by at least one wrapper. In the disclosure, the aerosol generating article may be referred to as a stick.

The cartridge mentioned in the disclosure may contain an aerosol generating material in any one state among a liquid state, a solid state, a gaseous state, a gel state, and the like. The aerosol generating material may include a liquid composition. For example, the liquid composition may be a liquid including a tobacco-containing material having a volatile tobacco flavor component, or may be a liquid including a non-tobacco material. The cartridge may include a storage containing an aerosol generating material and/or a liquid delivery unit impregnated with (containing) the aerosol-generating material. For example, the liquid delivery unit may include a wick or the like, such as a cotton fiber, a ceramic fiber, a glass fiber, or porous ceramic. The cartridge heater 24 may be included in the cartridge, as a coil-shaped structure that is wound around the liquid delivery unit or in a structure in contact with one side of the liquid delivery unit. Alternatively, the cartridge heater 24 may be included in an aerosol generating device 1 that is separable from the cartridge.

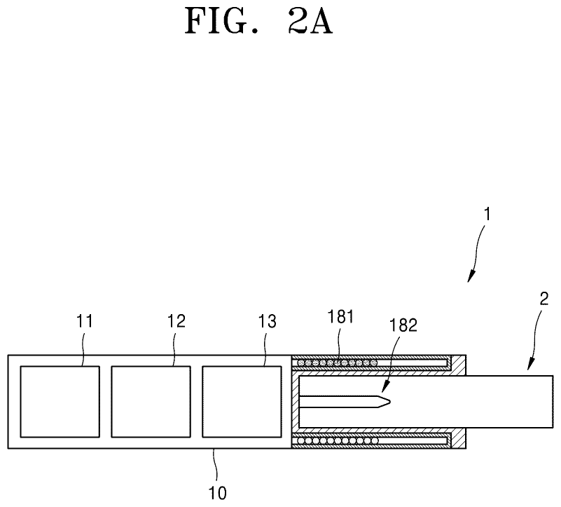

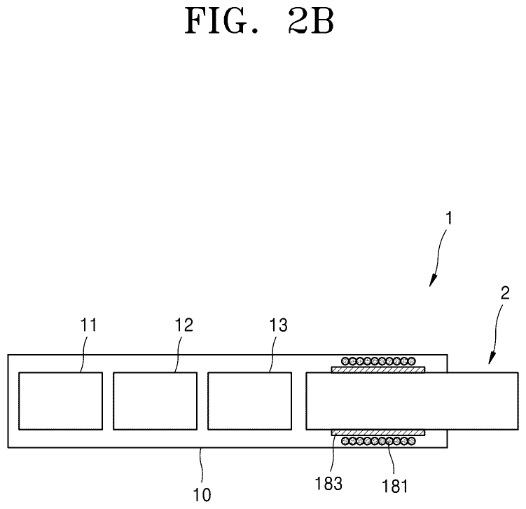

FIG. 2A illustrates an aerosol generating device according to an embodiment and FIG. 2B illustrates an aerosol generating device according to an embodiment.

According to an embodiment, the aerosol generating device 1 may include a housing 10, the power supply 11, the controller 12, the sensor unit 13, and/or a heater 182 or 183 (e.g., the heater 18 of FIG. 1). However, the components included in the aerosol generating device 1 are not limited to those shown in FIG. 2A or 2B. It may be understood by those skilled in the art that some of the components shown in FIG. 2A or 2B may be omitted or new components may be added. The aerosol generating device 1 illustrated in FIG. 2A may be referred to as an ‘internal heating type’ aerosol generating device that heats the inside of an aerosol generating article 2. The aerosol generating device 1 illustrated in FIG. 2B may be referred to as an ‘external heating type’ aerosol generating device that heats the outside of the aerosol generating article 2. In the drawings below, any description that overlaps with FIG. 1 will be omitted.

According to an embodiment, the housing 10 may provide a space opened upward so that the aerosol generating article 2 may be inserted. In the disclosure, the upwardly-opened space may be referred to as an insertion space. The insertion space may be recessed toward the inside of the body 10 by a certain depth so that at least a portion of the aerosol generating article 2 may be inserted thereinto. The depth of the insertion space may be equal to or greater than a length of a region in the aerosol generating article 2, in which an aerosol generating material and/or a medium is included. A lower end of the aerosol generating article 2 may be inserted into the housing 10, and an upper end of the aerosol generating article 2 may protrude to the outside of the housing 10. A user may inhale aerosol by holding, in his or her mouth, the upper end of the aerosol generating article 2 exposed to the outside.

According to an embodiment, the heaters 182 and 183 may heat the aerosol generating article 2.

Referring to FIG. 2A, the heater 182 may be implemented as an internal heating heater.

According to an embodiment, the internal heating heater may extend long upward in a space (i.e., the insertion space) into which the aerosol generating article 2 is inserted. As illustrated in FIG. 2A, the internal heating heater may include a rod-shaped heating element or a needle-shaped heating element. However, the internal heating heater may include any of various heating elements, such as a tube-shaped heating element or a plate-shaped heating element. The internal heating heater may be inserted through a lower side of the aerosol generating article 2.

According to an embodiment, the internal heating heater may include an electrically resistive heater and/or an induction heating heater.

For example, the electrically resistive heater may include an electrically resistive material on the inside (e.g., an inner hollow or an inner surface) or the outside (e.g., an outer surface), and may be heated as a current flows through the electrically resistive material. In this case, the electrically resistive heater may be electrically connected to the power supply 11, and may directly generate heat by receiving a current from the power supply 11. An induction coil 181 may be omitted.

For example, in the case of induction heating heaters, the aerosol generating device 1 may include the induction coil 181 surrounding at least a portion of the internal heating heater (e.g., being positioned outside to correspond to a length of at least a portion of the heater). In this case, a magnetic flux concentrator, etc. may be further included on the outside of the induction coil 181 in order to increase the efficiency of induction heating. An induction heating heater may include a susceptor, and may generate heat based on a magnetic field generated by the induction coil 181. According to an embodiment, the induction heating heater (e.g., a susceptor) (or a heater module including the induction heating heater) may be arranged to be detachable from the housing 10.

According to an embodiment, the heater 181 may be multiple heaters. The multiple heaters may include a first heater and a second heater, and may be inserted into the aerosol generating article 2. The first heater and the second heater may be arranged in parallel to each other in a longitudinal direction. The first heater and the second heater may operate as electrically resistive heaters and/or induction heating heaters, and may be sequentially heated or may be simultaneously heated. In this case, the first heater and the second heater may be respectively arranged at locations corresponding to longitudinal locations of two or more aerosol generating rods. Alternatively, the first heater and the second heater may be respectively arranged at locations corresponding to longitudinal locations of a first portion and a second portion of one aerosol generating rod. When the heater 182 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 182. Three or more heaters and/or three or more induction coils may be included.

According to an embodiment, a susceptor may be disposed (or included) in the inside (e.g., the medium portion) of the aerosol generating article 2, and the susceptor included within the aerosol generating article 2 may be implemented to generate heat, based on the magnetic field generated by the induction coil 181.

Referring to FIG. 2B, the heater 183 may be an external heating heater.

According to an embodiment, the external heating heater may extend long upward around a space (i.e., the insertion space) into which the aerosol generating article 2 is inserted. For example, the external heating heater may be disposed to surround at least a portion of the insertion space. For example, the external heating heater may include a tubular shape (e.g., a cylindrical shape) including a hollow therein. The external heating heater may have a shape including a hollow on the inside and surrounding the hollow. In this case, the external heating heater may be supported by a polyimide film. A heater supported by such a film may be referred to as a film heater. The external heating heater may be disposed to surround at least a portion of the insertion space. The external heating heater may heat the outside of the aerosol generating article 2 inserted into the hollow.

According to an embodiment, the external heating heater may include an electrically resistive heater and/or an induction heating heater. A description of FIG. 2B that overlaps with FIG. 2A will be omitted. In the case of induction heating heaters, the aerosol generating device 1 may include an external heating heater implemented as a tube-shaped susceptor, and may include the induction coil 181 surrounding at least a portion of the external heating heater (e.g., being positioned outside to correspond to a length of at least a portion of the heater). The induction coil 181 may include a fan coil. When the external heating heater is an electrically resistive heater, heat generation is possible through a current flow on a tube-shaped electrically resistive heater (e.g., a film heater), and thus the separate induction coil 181 may be omitted. Insulation may also be disposed on the outside of the external heating heater. Accordingly, the heat radiated outward by the heater 183 and applied to the outside of the housing 10 may be reduced.

According to one embodiment, the heater 183 may be multiple heaters, and the first heater and the second heater may be arranged side by side along the longitudinal direction so as to each surround at least a portion of the insertion space. The first heater and the second heater may operate as electrically resistive heaters and/or induction heating heaters, and may be sequentially heated or may be simultaneously heated. When the heater 183 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 183.

Unlike what shown in FIG. 2A or FIG. 2B, the heater 182 of FIG. 2A and the heater 183 of FIG. 2B may be included together in the aerosol generating device 1. In this case, the heater 182 may heat the inside of the aerosol generating article 2, and the heater 183 may heat the outside of the aerosol generating article 2.

According to an embodiment, the aerosol generating device 1 may be provided with an airflow channel through which air flows. For example, the housing 10 may include a structure (e.g., a hole) in which air may be introduced from the outside into the housing 10. The air introduced into the housing 10 may be introduced into the aerosol generating article 2 through the lower end (i.e., an upstream side) of the aerosol generating article 2. Aerosol generated based on the heating of the aerosol generating article 2, together with the introduced air, may be inhaled into the user's mouth through the upper end (i.e., the downstream side) of the aerosol generating article 2.

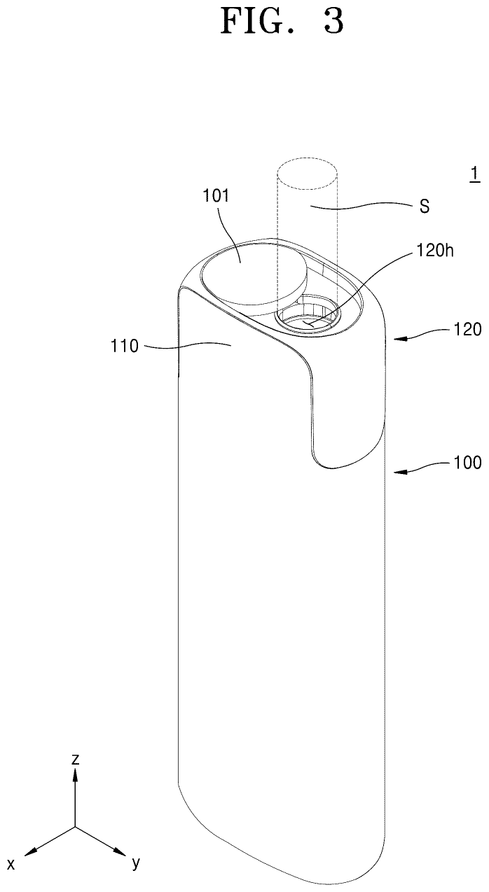

FIG. 3 is a perspective view of an aerosol generating device according to an embodiment.

Referring to FIG. 3, an aerosol generating device 1 (e.g., the aerosol generating device 1 of FIG. 1 or FIGS. 2A and 2B) according to an embodiment may include a housing 100 (e.g., the housing 10 of FIGS. 2A and 2B) capable of accommodating at least a portion of an aerosol generating article S (e.g., the aerosol generating article 2 of FIGS. 2A and 2B).

The housing 100 may form the overall appearance of the aerosol generating device 1, and components of the aerosol generating device 1 may be arranged in the internal space of the housing 100. For example, a heater assembly, a power source, and/or a control unit for heating the aerosol generating article S may be arranged in the internal space of the housing 100, but the components of the aerosol generating device 1 arranged in the internal space of the housing 100 are not limited thereto.

In the drawing, only an embodiment in which the overall appearance of the aerosol generating device 1 is formed in a columnar shape with an oval cross-section is illustrated, but the shape of the aerosol generating device 1 is not limited to the illustrated embodiment. In another embodiment (not illustrated), the aerosol generating device 1 may be formed in an overall cylindrical shape, or may be formed in a polygonal columnar shape (e.g., a triangular columnar shape or a square columnar shape).

According to an embodiment, the housing 100 may include a first housing 110 and a second housing 120 that is detachably coupled to the first housing 110. The first housing 110 and the second housing 120 may form the outer appearance of the aerosol generating device 1 when coupled to each other, and components of the aerosol generating device 1 may be arranged in a space between the first housing 110 and the second housing 120. For example, the first housing 110 may form the bottom surface of the aerosol generating device 1 and at least a portion of the side surface of the aerosol generating device 1, and the second housing 120 may form the top surface of the aerosol generating device 1 and the remaining portion of the side surface of the aerosol generating device 1. However, the disclosure is not limited thereto.

The second housing 120 may include an insertion hole 120h into which the aerosol generating article S may be inserted, and at least a portion of the aerosol generating article S may pass through the insertion hole 120h and be accommodated in a heater assembly (not shown) arranged in the space between the first housing 110 and the second housing 120. In the drawing, only an embodiment in which the insertion hole 120h is arranged in an upper area (e.g., an area in the z direction) of the second housing 120 is illustrated, but the arrangement position of the insertion hole 120h is not limited thereto.

The aerosol generating article S accommodated in the heater assembly after passing through the insertion hole 120h may be heated inside the heater assembly, and when the aerosol generating article S is heated, an aerosol may be generated inside the heater assembly. For example, the aerosol generating article S may be accommodated in a receiving portion of the heater assembly, and a heater may heat the aerosol generating article S accommodated in the receiving portion to generate an aerosol. The aerosol generated from the heater assembly may be provided to a user when the user contacts the user's oral region to the aerosol generating article S and inhales.

According to an embodiment, the aerosol generating device 1 may further include a cover 101 movably arranged in the second housing 120 to open or close the insertion hole 120h.

In an example, the cover 101 may be arranged to cover the insertion hole 120h in a first position (or ‘closed position’) so that the insertion hole 120h is not exposed to the outside of the aerosol generating device 1. The cover 101 may prevent external foreign materials from entering the interior of the housing 100 through the insertion hole 120h by preventing the insertion hole 120h from being exposed to the outside in the first position.

In another example, as the cover 101 moves from the first position to a second position (or ‘open position’), the insertion hole 120h may be exposed to the outside. When the cover 101 is in the second position, the insertion hole 120h may be exposed, and thus, the aerosol generating article S may be inserted into the interior of the housing 100 through the insertion hole 120h.

According to an embodiment, the cover 101 may slide between the first position and the second position along a groove formed in an area (e.g., an area facing the z direction) of the second housing 120, but the method of moving the cover 101 is not limited thereto. In addition, the cover 101 moved from the first position to the second position may return to the first position by elastic force (or ‘restoring force’) even without a separate operation by the user, but is not limited thereto.

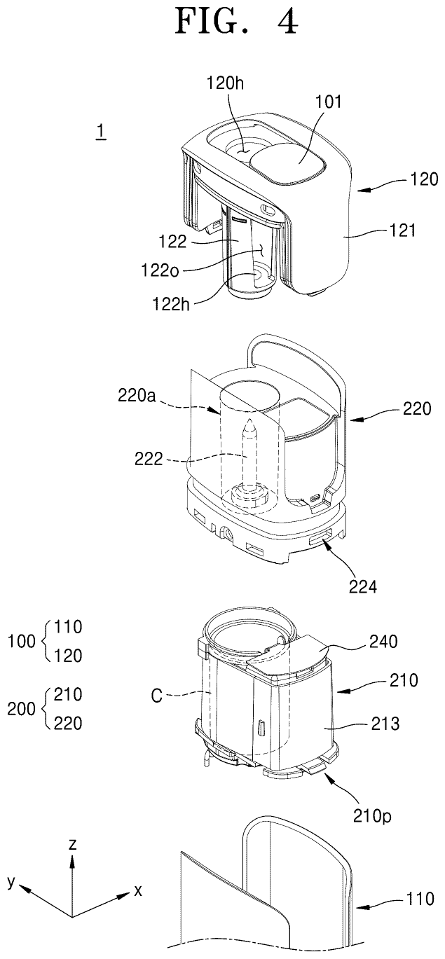

Hereinafter, components of the aerosol generating device 1 will be specifically described with reference to FIG. 4.

FIG. 4 is an exploded perspective view of the aerosol generating device of FIG. 3.

Referring to FIG. 4, an aerosol generating device 1 (e.g., the aerosol generating device 1 of FIG. 3) according to an embodiment may include a housing 100 (e.g., the housing 100 of FIG. 3) and a heater assembly 200. The components of the aerosol generating device 1 may be substantially the same as or similar to at least one of the components of the aerosol generating device 1 of FIG. 3, and redundant descriptions thereof are omitted below.

The housing 100 may include a first housing 110 (e.g., the first housing 110 of FIG. 3) and a second housing 120 (e.g., the second housing 120 of FIG. 3) that may be detachably coupled to the first housing 110.

The first housing 110 may form a portion of the outer appearance of the aerosol generating device 1, and may accommodate the components of the aerosol generating device 1 and protect the accommodated components. For example, the heater assembly 200 may be accommodated in the internal space of the first housing 110, and the first housing 110 may protect the heater assembly 200 from external impact or the inflow of external foreign materials.

The second housing 120 may form the outer appearance of the aerosol generating device 1 together with the first housing 110, and may remove residues of an aerosol generating article (e.g., the aerosol generating article S of FIG. 3) remaining inside the heater assembly 200 when detached from the first housing 110.

According to an embodiment, the second housing 120 may include a base 121, and a support portion 122 (or an ‘extractor’) inserted into the interior of a receiving portion 220a (or an ‘aerosol generating article receiving portion’) of the heater assembly 200 to support the aerosol generating article accommodated in the receiving portion 220a.

The base 121 may form the outer appearance of the aerosol generating device 1 together with the first housing 110 when the first housing 110 and the second housing 120 are coupled to each other. For example, the base 121 may form the top surface of the aerosol generating device 1 and a portion of the side surface of the aerosol generating device 1, and the first housing 110 may form another portion of the side surface of the aerosol generating device 1 and the bottom surface of the aerosol generating device 1.

The base 121 may include an insertion hole 120h into which an aerosol generating article may be inserted, and the aerosol generating article may be accommodated inside the receiving portion 220a of the heater assembly 200 after passing through the insertion hole 120h.

According to an embodiment, a cover 101 (e.g., the cover 101 of FIG. 3) may be movably arranged on the base 121 to open or close the insertion hole 120h. For example, the cover 101 may open the insertion hole 120h to the outside of the aerosol generating device 1 at a first position, and may close the insertion hole 120h so that the insertion hole 120h is not exposed to the outside at a second position.

The support portion 122 may extend in a direction (e.g., in the −z direction) toward the heater assembly 200 from an area adjacent to the insertion hole 120h of the base 121, and may be arranged to be inserted into the interior of the receiving portion (220a) and surround an aerosol generating article received in the receiving portion (220a).

According to an embodiment, the support portion 122 may include a cavity for receiving an aerosol generating article inserted through the insertion hole 120h, and an opening 1220 formed on a side of the support portion 122 to open at least a portion of the cavity.

When an aerosol generating article is inserted through the insertion hole 120h while the support portion 122 of the second housing 120 is inserted into the interior of the receiving portion 220a of the heater assembly 200,

The inserted aerosol generating article may be accommodated in the cavity of the support portion 122, and external air may be introduced into the interior of the cavity through the opening 1220. In this case, the external air introduced into the interior of the cavity through the opening 1220 may be mixed with vapor generated when the aerosol generating article is heated to generate an aerosol. As shown in the drawing, the opening 1220 may extend along the length direction of the support portion 122 to at least a portion of the side surface of the support portion 122, but the shape of the opening 1220 is not limited thereto.

The support portion 122 may allow the residue of the aerosol generating article remaining in the receiving portion 220a to be discharged to the outside when the second housing 120 is detached from the first housing 110 through the above-described arrangement structure.

For example, during the use of the aerosol generating device 1, a portion of the aerosol generating article may break, or a residue generated after the aerosol generating article is heated may remain inside the receiving portion 220a. In this case, because the support portion 122 is arranged to surround the aerosol generating article inside the receiving portion 220a, the support portion 122 may surround even the residue generated during the use of the aerosol generating material, and as a result, when the support portion 122 is detached from the receiving portion 220a by detaching the second housing 120, the residue of the aerosol generating material may also be discharged to the outside of the receiving portion 220a together with the support portion 122.

According to an embodiment, the support portion 122 may further include a through hole 122h formed in the bottom surface of the support portion 122. When the second housing 120 is coupled to the first housing 110, the susceptor 222 (e.g., the heater 182 of FIG. 2A) of the heater assembly 200 may pass through the through hole 122h and be positioned inside the cavity of the support portion 122, and the susceptor 222 positioned inside the cavity may be inserted into an aerosol generating article accommodated in the cavity of the support portion 122. In other words, the susceptor 222 of the heater assembly 200 may be positioned inside the cavity through the through hole 122h and may be inserted into an aerosol generating article accommodated in the cavity and heat the aerosol generating article.

The heater assembly 200 may be accommodated inside the first housing 110 and may generate an aerosol by heating an aerosol generating article inserted into the heater assembly 200 through the insertion hole 120h of the second housing 120.

According to an embodiment, the heater assembly 200 may include a coil assembly 210 and a cover housing 220 coupled to the coil assembly 210.

The coil assembly 210 may include a coil C, a shielding member 213, and a sensor 240 and may be a component of the aerosol generating device 1 in which the coil C, the shielding member 213, and the sensor 240 are modularized. That is, the coil assembly 210 may be a component of the aerosol generating device 1 in which the coil C, the shielding member 213, and the sensor 240 are integrated.

The coil C may be arranged to surround the susceptor 222 of the cover housing 220 and may generate an alternating magnetic field when power is supplied. For example, the coil C may surround the susceptor 222 positioned inside the receiving portion 220a by being arranged to surround the outer surface of the receiving portion 220a when the coil assembly 210 is inserted into the cover housing 220 and the coil assembly 210 and the cover housing 220 are coupled to each other. In this case, the susceptor 222 may generate heat in response to the alternating magnetic field generated from the coil C, thereby heating the aerosol generating article.

The shielding member 213 may shield the magnetic field from leaking to the outside of the coil assembly 210. For example, the shielding member 213 may be arranged to surround the coil C so that the magnetic field generated from the coil C does not leak to the outside of the coil assembly 210.

The sensor 240 may obtain information necessary for the operation of the aerosol generating device 1. For example, the sensor 240 may obtain information for detecting whether the first housing 110 and the second housing 120 have been attached or detached, or whether an aerosol generating article has been inserted into the receiving portion 220a.

In the case of individually assembling the coil C, the shielding member 213, and the sensor 240 during the manufacturing of the aerosol generating device 1, the positions of the coil C, the shielding member 213, and/or the sensor 240 may deviate from designed positions due to deviations (or ‘assembly deviations’) occurring during an assembly process, and as a result, the overall performance of the aerosol generating device 1 may deteriorate.

In an example, when the coil C deviates from a designed position, the magnetic field may not be radiated in an intended direction, which may reduce the heating efficiency of the susceptor 222. In another example, when the shielding member 213 deviates from a designed position, a portion of the magnetic field generated from the coil C may leak to the outside of the aerosol generating device 1. In addition, when the sensor 240 deviates from a designed position, the detection accuracy of whether an aerosol generating article has been inserted or whether the second housing 120 has been attached or detached may deteriorate.

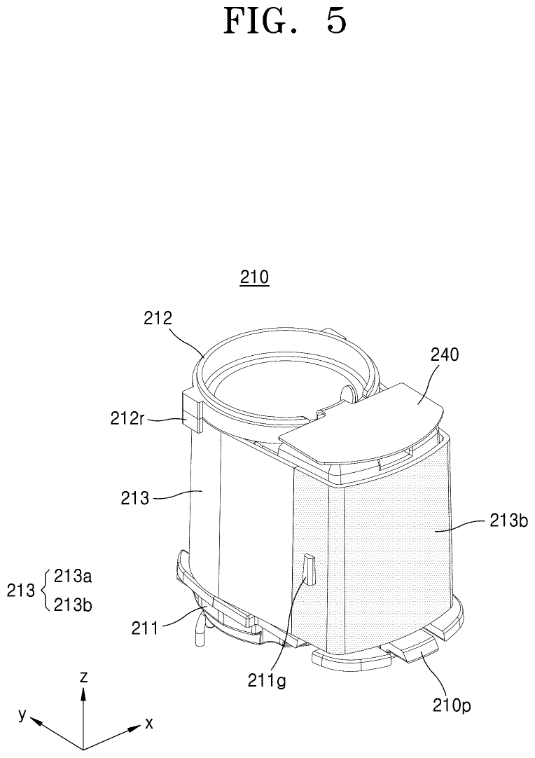

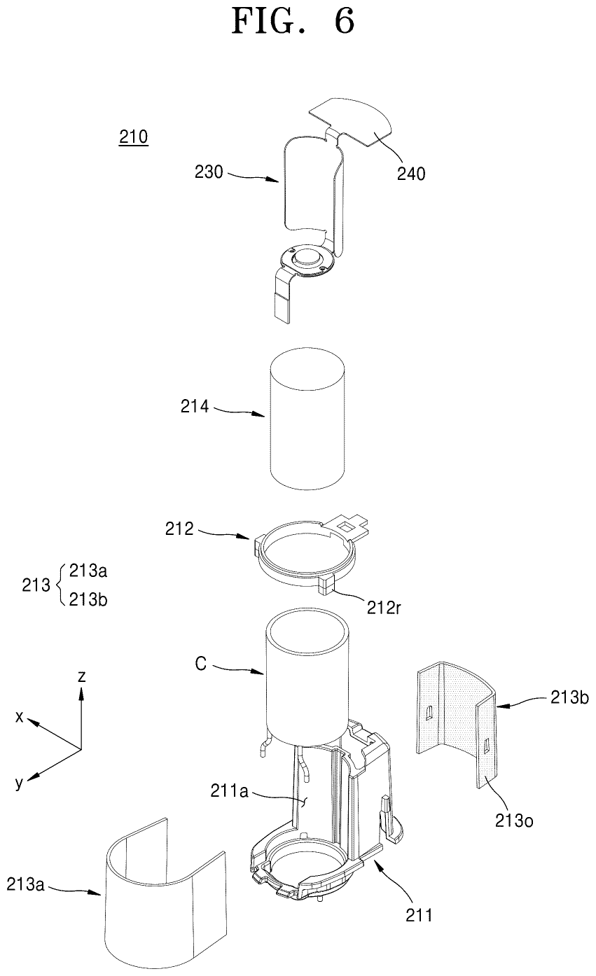

According to an embodiment, the aerosol generating device 1 may simplify the manufacturing process of the aerosol generating device 1 through the coil assembly 210 in which the coil C, the shielding member 213, and the sensor 240 are modularized, and may prevent deviations that may occur during the assembly process of the components of the aerosol generating device 1, thereby stably maintaining the performance of the aerosol generating device 1. The detailed configuration of the coil assembly 210 will be described below with reference to FIGS. 5 and 6.

The cover housing 220 may be coupled to the coil assembly 210 to protect the coil assembly 210, and may include the receiving portion 220a into which at least a portion of an aerosol generating article is inserted, and the susceptor 222 arranged to be insertable into the aerosol generating article in the receiving portion 220a.

In a state where the first housing 110 and the second housing 120 are coupled to each other, the support portion 122 of the second housing 120 may be positioned inside the receiving portion 220a and may be arranged to surround an aerosol generating article accommodated in the receiving portion 220a through the insertion hole 120h.

The susceptor 222 may be inserted into the aerosol generating article accommodated in the receiving portion 220a and may heat the aerosol generating article by generating heat by an alternating magnetic field generated from the coil C. Vapor generated when the aerosol generating article is heated may be mixed with external air introduced into the receiving portion 220a through the opening 1220 of the support portion 122 to generate an aerosol.

According to an embodiment, the coil assembly 210 and the cover housing 220 may be coupled to each other in such a way that the coil assembly 210 is inserted into the cover housing 220. The cover housing 220 may include a coupling hole 224 and the coil assembly 210 may include a rib 210p that may be inserted into the coupling hole 224. For example, the rib 210p may be positioned to protrude from a portion of a first bracket 211 and may be inserted into the coupling hole 224, which is positioned corresponding to the rib 210p, when the coil assembly 210 and the cover housing 220 are coupled to each other. As the rib 210p of the coil assembly 210 is hook-coupled to the coupling hole 224 of the cover housing 220, the coil assembly 210 may be fixed in a state in which the coil assembly 210 is inserted into the cover housing 220, but the manner in which the rib 210p is coupled to the coupling hole 224 is not limited thereto.

As the coil assembly 210 and the cover housing 220 are coupled to each other, the assembly of the heater assembly 200 may be completed, and when the assembled heater assembly 200 is accommodated in the first housing 110 and the second housing 120 is coupled to the first housing 110, the assembly of the aerosol generating device 1 may be finally completed.

According to an embodiment, the aerosol generating device 1 may simplify the assembly process of the heater assembly 200 through the modularized coil assembly 210 as described above, and as a result, the time required for the overall assembly of the aerosol generating device 1 may be reduced.

Hereinafter, with reference to FIGS. 5 and 6, the coil assembly 210 in which components are modularized will be specifically described.

FIG. 5 is a perspective view of a coil assembly of an aerosol generating device according to an embodiment, and FIG. 6 is an exploded perspective view of the coil assembly of FIG. 5. In this case, a coil assembly 210 of FIGS. 5 and 6 may be an embodiment of the coil assembly 210 of FIG. 4, and redundant descriptions thereof are omitted below.

Referring to FIGS. 5 and 6, the coil assembly 210 according to an embodiment may include a coil C, a first bracket 211, a second bracket 212, a shielding member 213, and sensors 230 and 240. The components of the coil assembly 210 are not limited thereto, and at least one (e.g., the sensors 230 and 240) of the components described above may be omitted or other components may be added according to an embodiment.

The first bracket 211 (or ‘lower bracket’) may form the outer appearance of the coil assembly 210 and may support the components of the coil assembly 210. According to an embodiment, the first bracket 211 may include an accommodation space 211a for accommodating the coil C and may support the coil C accommodated in the accommodation space 211a. For example, the first bracket 211 may be arranged to contact at least a portion of the outer surface of the coil C accommodated in the accommodation space 211a and a lower area (e.g., an area in the −z direction) of the coil C, thereby fixing the position of the coil C.

The second bracket 212 (or ‘upper bracket’) may be coupled to one end (e.g., one end facing the z direction) of the first bracket 211, and may support or fix the coil C together with the first bracket 211. For example, the second bracket 212 may be arranged to contact an upper area (e.g., an area in the z direction) of the coil C while being coupled to the first bracket 211, and may fix the position of the coil C together with the first bracket 211.

According to an embodiment, the coil assembly 210 may prevent the coil C from moving during the operation of the aerosol generating device (e.g., the aerosol generating device 1 of FIGS. 3 and 4) through a structure in which the coil C is firmly supported by the first bracket 211 and the second bracket 212 between the first bracket 211 and the second bracket 212. As a result, the reduction in the heating efficiency of the aerosol generating device due to the movement of the coil C may be prevented.

The shielding member 213 may be fixed by the first bracket 211 and the second bracket 212, and may block or shield the magnetic field generated from the coil C from being radiated to the outside. For example, the shielding member 213 may be arranged to surround the side surface of the first bracket 211 and the side surface of the coil C, thereby blocking the magnetic field from being radiated to the outside of the heater assembly or the coil assembly 210. In the disclosure, when a surface facing the z direction is defined as the top surface and a surface facing the −z direction is defined as a bottom surface, the term ‘side surface’ may refer to a surface (e.g., a surface facing the x direction or the y direction) surrounding the space between the top surface and the bottom surface, and the expression may be used with the same meaning hereinafter.

According to an embodiment, the shielding member 213 may include a first shielding member 213a and a second shielding member 213b.

The first shielding member 213a may be arranged to surround a portion of the side surface of the coil C and a portion of the side surface of the first bracket 211 to block the magnetic field from leaking to the outside of the heater assembly or the coil assembly 210. For example, the first shielding member 213a may be coupled to the first bracket 211 in such a way that at least a portion of the first shielding member 213a is adhered to the coil C and/or the first bracket 211 through an adhesive member (not shown), but is not limited thereto.

The second shielding member 213b may be arranged to surround the remaining portion of the side surface of the first bracket 211 except for the portion of the side surface of the first bracket 211, which is surrounded by the first shielding member 213a, to block the magnetic field from leaking to the outside of the heater assembly or the coil assembly 210. For example, the second shielding member 213b may be coupled to the first bracket 211 in such a way that at least a portion of the second shielding member 213b is adhered to the first bracket 211 through an adhesive member, but is not limited thereto.

According to an embodiment, a portion 2130 (or ‘overlapping portion’) of the second shielding member 213b may be positioned on the first shielding member 213a and may be arranged to overlap the first shielding member 213a. In other words, the portion 2130 of the second shielding member 213b may be arranged to cover the first shielding member 213a.

In the case where the shielding member 213 is integrally formed as one body, the position of the shielding member 213 has to be aligned, and thus, the assembly of the coil assembly 210 may not be easy. On the other hand, when the shielding member 213 is divided into the first shielding member 213a and the second shielding member 213b, the convenience of assembly may be improved, but a portion of the magnetic field generated from the coil C may leak to the outside through the space between the first shielding member 213a and the second shielding member 213b that occurs during the assembly process.

According to an embodiment, the coil assembly 210 has a structure in which the portion 2130 of the second shielding member 213b is arranged to overlap the first shielding member 213a, thereby completely shielding the side surfaces of the first bracket 211 and the coil C, thereby preventing the magnetic field from leaking to the outside of the coil assembly 210.

According to an embodiment, the first bracket 211 may include a first fixing member 211g protruding from the side surface of the first bracket 211 to fix the position of the shielding member 213. For example, the first fixing member 211g may be arranged to pass through an area where the first shielding member 213a and the second shielding member 213b overlap each other to fix the positions of the first shielding member 213a and the second shielding member 213b, but is not limited thereto.

According to another embodiment, the second bracket 212 may include a second fixing member 212r protruding from the second bracket 212 in a direction (e.g., in the −z direction) toward the coil C to fix the shielding member 213. For example, the second fixing member 212r may be arranged to surround a portion of the outer surface of the shielding member 213 to fix the position of the shielding member 213, but is not limited thereto.

The coil assembly 210 according to an embodiment may prevent a magnetic field from leaking to the outside when the shielding member 213 moves during the operation of the aerosol generating device by fixing the position of the shielding member 213 through the first fixing member 211g and/or the second fixing member 212r.

The sensors 230 and 240 may be arranged to be supported by the first bracket 211 and/or the second bracket 212 and may obtain data necessary for the operation of the aerosol generating device.

According to an embodiment, the sensors 230 and 240 may include a first sensor 230 for detecting whether an aerosol generating article has been accommodated inside a receiving portion (e.g., the receiving portion 220a of FIG. 5), and a second sensor 240 for detecting whether a second housing (e.g., the second housing 120 of FIG. 5) has been detached from a first housing (e.g., the first housing 110 of FIG. 5).

The first sensor 230 may include a capacitance sensor for detecting a change in a capacitance value, and may be arranged inside the coil C to detect a change in a capacitance value inside the receiving portion when the coil assembly 210 and the cover housing are coupled to each other.

According to an embodiment, the first sensor 230 may be arranged to surround the outer surface of the receiving portion between the coil C and the receiving portion when the coil assembly 210 and the cover housing are coupled to each other, and may detect a change in the capacitance value inside the receiving portion depending on whether an aerosol generating article has been inserted.

According to an embodiment, the coil assembly 210 may further include a tube 214 for fixing the first sensor 230. The tube 214 may be arranged to surround the first sensor 230 and the receiving portion when the coil assembly 210 and the cover housing are coupled to each other, and may fix the first sensor 230 to a position adjacent to the receiving portion by pressing the first sensor 230 in a direction toward the receiving portion. For example, the tube 214 may be a heat shrink tube that shrinks in response to heat, but is not limited thereto.

The coil assembly 210 may more precisely detect a change in the capacitance value inside the receiving portion depending on whether an aerosol generating article has been inserted by allowing the first sensor 230 to be positioned adjacent to the receiving portion through the tube 214.

The second sensor 240 may include an inductive sensor for detecting a change in an inductance value, and may detect a change in an inductance value around the coil assembly 210 depending on whether an external object is approaching.

According to an embodiment, the second sensor 240 may be positioned on the second bracket 212, and may detect a change in the inductance value depending on whether an external object (e.g., the second housing 120) is approaching the surroundings of the coil assembly 210. For example, the second sensor 240 may be positioned between the second bracket 212 and the cover housing when the coil assembly 210 and the cover housing are coupled to each other. The position of the second sensor 240 may be fixed by the second bracket 212 and the cover housing. The aerosol generating device may detect whether the second housing 120 has been detached from the first housing 110 through the second sensor 240, and a detailed description thereof will be provided below.

According to an embodiment, the second sensor 240 may be arranged to be connected to one end of the first sensor 230, and thus, the first sensor 230 and the second sensor 240 may be formed integrally with each other. For example, the first sensor 230 and the second sensor 240 may be each implemented in a pattern shape on a single flexible printed circuit board (FPCB).

According to an embodiment, the coil assembly 210 may simplify the assembly process of the coil assembly 210 through a structure in which the first sensor 230 and the second sensor 240 are formed integrally with each other, and as a result, the overall assembly process of the aerosol generating device may be simplified, thereby improving the convenience of assembly of the aerosol generating device.

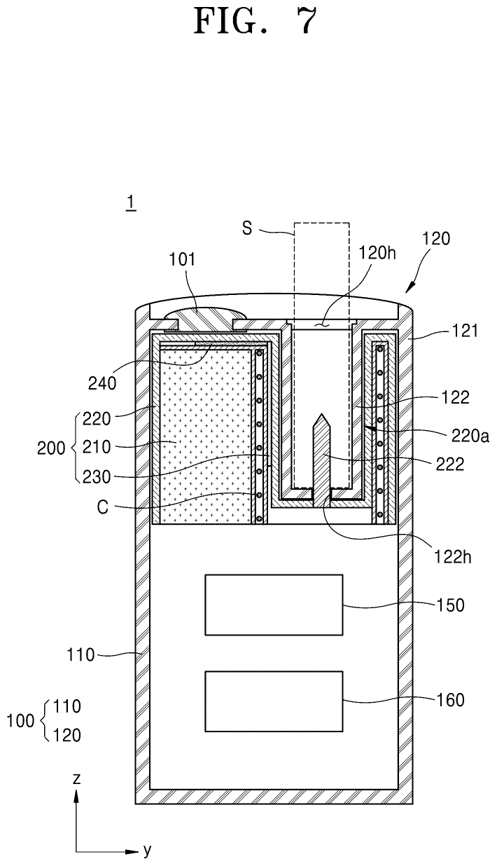

Hereinafter, with reference to FIG. 7, the process in which the aerosol generating device operates through the components of the coil assembly 210 will be specifically described.

FIG. 7 is a cross-sectional view of an aerosol generating device according to an embodiment. In this case, FIG. 7 may be a drawing that briefly illustrates a cross-section of the aerosol generating device 1 of FIG. 3, and the components of the aerosol generating device 1 are not limited to those illustrated. In another embodiment, the aerosol generating device 1 may further include other components (e.g., the tube 214 of FIG. 6).

Referring to FIG. 7, the aerosol generating device 1 according to an embodiment (e.g., the aerosol generating device 1 of FIG. 3 or 4) may include a housing 100 (e.g., the housing 100 of FIG. 4) and a heater assembly 200 (e.g., the heater assembly 200 of FIG. 4). The components of the aerosol generating device 1 may be substantially the same as or similar to at least one of the components of the aerosol generating device 1 of FIGS. 3 and 4, and redundant descriptions thereof are omitted.

The housing 100 may include a first housing 110 (e.g., the first housing 110 of FIG. 3 or 4), a base 121 (e.g., the base 121 of FIG. 5), and a support portion 122 (e.g., the support portion 122 of FIG. 5), and may further include a second housing 120 (e.g., the second housing 120 of FIG. 3 or 4) that may be detachably coupled to the first housing 110.

A space in which the components of the aerosol generating device 1 may be accommodated may be formed between the first housing 110 and the second housing 120. For example, a power source 150 (e.g., the power source 11 of FIG. 1), a control unit 160 (e.g., the control unit 12 of FIG. 1), and a heater assembly 200 may be accommodated in the space between the first housing 110 and the second housing 120, but the components accommodated in the space between the first housing 110 and the second housing 120 are not limited thereto.

The heater assembly 200 may include a coil assembly 210 and a cover housing 220, and may heat an aerosol generating article S to generate an aerosol. The aerosol generating article S may be accommodated in a receiving portion 220a of the cover housing 220 by passing through an insertion hole 120h of the second housing 120, and a susceptor 222 may be arranged so that the aerosol generating article S may be inserted into the receiving portion 220a. A coil C of the heater assembly 200 may generate an alternating magnetic field in response to power supply, and the susceptor 222 may generate heat in response to the alternating magnetic field to heat the aerosol generating article S.

The power source 150 may supply power required for the operation of the aerosol generating device 1. For example, the power source 150 may include at least one battery that is rechargeable or disposable, and may supply power through the battery that is operatively connected to components of the aerosol generating device 1. In the disclosure, the expression ‘operably connected’ may mean a state in which components are connected to each other so that the components may exchange signals by wireless communication, or exchange optical signals and/or magnetic signals, and the expression may be used with the same meaning hereinafter.

In an example, the power source 150 may supply power necessary for operation to the coil C of the heater assembly 200, and the coil C may generate an alternating magnetic field based on the power supplied from the power source 150 to heat the susceptor 222. In another example, the power source 150 may also supply power necessary for operation of the control unit 160, the first sensor 230, and/or the second sensor 240.

The control unit 160 may control the overall operation of the aerosol generating device 1. For example, the control unit 160 may include at least one processor and may be operatively connected to components of the aerosol generating device 1 to control the operation of the aerosol generating device 1.

According to an embodiment, the control unit 160 may be operatively connected to the first sensor 230 and may detect whether an aerosol generating article has been inserted into the interior of the receiving portion 220a of the heater assembly 200 based on data transmitted from the first sensor 230. For example, the first sensor 230 may include a capacitance sensor arranged to surround the receiving portion 220a and may detect a change in a capacitance value of the receiving portion 220a. Depending on whether an aerosol generating article S has been accommodated in the receiving portion 220a, the dielectric constant inside the receiving portion 220a may change, thereby causing the capacitance value to vary, and the first sensor 230 may transmit, to the control unit 160, data on the capacitance value of the receiving portion 220a that varies.

The control unit 160 may detect whether the aerosol generating article S has been inserted into the receiving portion 220a based on the data on the capacitance value transmitted from the first sensor 230. For example, when the amount of change in the capacitance value transmitted from the first sensor 230 is greater than a specified value, the control unit 160 may determine that the aerosol generating article S is inserted into the receiving portion 220a.

In addition, the control unit 160 may heat the susceptor 222 through the coil C if it is determined that the aerosol generating article S is inserted into the receiving portion 220a. That is, the control unit 160 may determine whether the aerosol generating article S has been inserted into the receiving portion 220a through the first sensor 230, and may preheat or heat the susceptor 222 based on the determination result.

According to another embodiment, the control unit 160 may be operatively connected to the second sensor 240, and may detect whether the second housing 120 has been detached from the first housing 110 based on data transmitted from the second sensor 240. For example, the second sensor 240 may include an inductive sensor that is positioned in an area adjacent to the second housing 120 between an area (e.g., the second bracket 212 of FIG. 6) of the coil assembly 210 and the cover housing 220, and may detect a change in an inductance value according to the movement of the second housing 120.

When the first housing 110 and the second housing 120 are coupled to each other, the second sensor 240 and the second housing 120 may be positioned adjacent to each other, but when the second housing 120 is detached from the first housing 110, the distance between the second sensor 240 and the second housing 120 may increase. At least one conductor (not shown) may be arranged in an area facing the second sensor 240 of the second housing 120, and accordingly, the inductance value detected by the second sensor 240 may vary depending on whether the second housing 120 has been attached or detached. In this case, the second sensor 240 may transmit, to the control unit 160, data on the variable inductance value that varies.

The control unit 160 may detect whether the second housing 120 has been detached from the first housing 110 based on the data on the inductance value transmitted from the second sensor 240. For example, the control unit 160 may determine that the second housing 120 is detached from the first housing 110 when the amount of change in the inductance value detected by the second sensor 240 is greater than or equal to a specified value.

In addition, when the control unit 160 determines that the second housing 120 is detached from the first housing 110, the control unit 160 may cut off the power supplied from the power source 150 to the coil C to prevent the susceptor 222 from generating heat.

A heater assembly for an aerosol generating device according to an embodiment may include a cover housing, and a coil assembly inserted into the cover housing, wherein the coil assembly may include a coil configured to generate an alternating magnetic field when power is supplied, a first bracket including a receiving space for accommodating the coil and supporting the coil accommodated in the receiving space, a second bracket coupled to one end of the first bracket and supporting the coil, and a shielding member arranged to surround side surfaces of the first bracket and the coil and configured to shield a magnetic field radiating from the coil to an outside of the heater assembly, wherein the first bracket and the second bracket may fix the shielding member.

In an example, the first bracket may include a first fixing member protruding from a side surface of the first bracket and fixing a position of the shielding member.

In another example, the second bracket may include a second fixing member protruding in a direction toward the coil and fixing the shielding member.

According to an embodiment, the shielding member may include a first shielding member arranged to surround a side surface of the coil and a portion of a side surface of the first bracket, and a second shielding member arranged to surround a remaining portion of the side surface of the first bracket except for the portion of the side surface of the first bracket.

In an example, a portion of the second shielding member may be positioned on the first shielding member and may be arranged to overlap the first shielding member.

According to an embodiment, the cover housing may include a receiving portion into which at least a portion of an aerosol generating article is inserted, and a susceptor arranged inside the receiving portion so as to be insertable into the aerosol generating article and configured to heat the aerosol generating article by generating heat by using an alternating magnetic field generated by the coil.

For example, the coil may be arranged to surround the receiving portion when the coil assembly is inserted into the cover housing.

According to an embodiment, the heater assembly may further include a first sensor arranged between the coil and the receiving portion to surround the receiving portion and configured to detect whether the aerosol generating article has been inserted into the receiving portion.

In addition, the heater assembly may further include a tube arranged to surround the first sensor and the receiving portion and configured to press the first sensor in a direction toward the receiving portion to fix the first sensor.

According to another embodiment, the heater assembly may further include a second sensor arranged between the second bracket and the cover housing and configured to detect a change in an inductance value around the heater assembly.

For example, the second sensor may be connected to one end of the first sensor and may be formed integrally with the first sensor.

In an example, the cover housing may include a coupling hole, and the coil assembly may further include a rib inserted into the coupling hole, wherein the coil assembly may be coupled to the cover housing when the rib is hook-coupled to the coupling hole.

In this case, the rib may be arranged to protrude from a portion of the first bracket.

An aerosol generating device according to an embodiment may include a heater assembly including a cover housing and a coil assembly inserted into the cover housing, and a housing accommodating the heater assembly, wherein the coil assembly may include a coil configured to generate an alternating magnetic field when power is supplied, a first bracket including a receiving space for accommodating the coil and supporting the coil accommodated in the receiving space, a second bracket coupled to one end of the first bracket and supporting the coil, and a shielding member arranged to surround side surfaces of the first bracket and the coil and configured to shield a magnetic field radiating from the coil to an outside of the heater assembly, and the cover housing may include a receiving portion into which at least a portion of an aerosol generating article is inserted, and a susceptor arranged inside the receiving portion so as to be insertable into the aerosol generating article and configured to heat the aerosol generating article by generating heat by using an alternating magnetic field generated by the coil, wherein the first bracket and the second bracket may fix the shielding member.

According to an embodiment, the housing may include a first housing accommodating the heater assembly, and a second housing detachably coupled to the first housing, the second housing including an insertion hole into which the aerosol generating article is insertable, and a support portion that is inserted into an interior of the receiving portion when coupled to the first housing and surrounds the aerosol generating article inserted into the receiving portion.

Some embodiments or other embodiments of the disclosure described above are not exclusive or distinct from each other. In some embodiments or other embodiments of the disclosure described above, respective components or functions may be used in combination with one another or combined with one another.

For example, a component A described in a particular embodiment and/or drawing and a component B described in another embodiment and/or drawing may be combined with each other. In other words, even when coupling between components is not directly described, the coupling may be made except when the coupling is described as impossible.

The above description should not be construed as being limited in all respects but should be considered illustrative. The scope of the disclosure should be determined by the logical interpretation of appended claims, and all changes within the equivalent scope of the disclosure are included in the scope of the disclosure.

According to various embodiments, a manufacturing process of an aerosol generating device may be simplified through a heater assembly in which components are modularized, thereby improving the convenience of coupling.

In addition, according to various embodiments, the components may be robustly coupled together through the heater assembly in which the components are modularized, thereby preventing a decrease in heating efficiency due to deviations occurring during an assembly process.

However, effects of the embodiments are not limited to the above-described effects, and effects not mentioned may be clearly understood by one of ordinary skill in the art to which the embodiments

What is claimed is:

1. A heater assembly for an aerosol generating device, the heater assembly comprising:
a cover housing; and
a coil assembly inserted into the cover housing,
wherein the coil assembly comprises:
a coil configured to generate an alternating magnetic field when power is supplied;
a first bracket comprising a receiving space for accommodating the coil and supporting the coil accommodated in the receiving space;
a second bracket coupled to one end of the first bracket and supporting the coil; and
a shielding member arranged to surround side surfaces of the first bracket and the coil and configured to shield a magnetic field radiating from the coil to an outside of the heater assembly,
wherein the first bracket and the second bracket fix the shielding member.

2. The heater assembly of claim 1, wherein the first bracket comprises a first fixing member protruding from a side surface of the first bracket and configured to fix a position of the shielding member.

3. The heater assembly of claim 1, wherein the second bracket comprises a second fixing member protruding in a direction toward the coil and configured to fix the shielding member.

4. The heater assembly of claim 1, wherein the shielding member comprises:
a first shielding member arranged to surround a side surface of the coil and a portion of a side surface of the first bracket; and
a second shielding member arranged to surround a remaining portion of the side surface of the first bracket except for the portion of the side surface of the first bracket.

5. The heater assembly of claim 4, wherein a portion of the second shielding member is positioned on the first shielding member and is arranged to overlap the first shielding member.

6. The heater assembly of claim 1, wherein the cover housing comprises:
a receiving portion into which at least a portion of an aerosol generating article is inserted; and
a susceptor arranged inside the receiving portion so as to be insertable into the aerosol generating article and configured to heat the aerosol generating article by generating heat by using an alternating magnetic field generated by the coil.

7. The heater assembly of claim 6, wherein the coil is arranged to surround the receiving portion when the coil assembly is inserted into the cover housing.

8. The heater assembly of claim 7, further comprising a first sensor arranged between the coil and the receiving portion to surround the receiving portion and configured to detect whether the aerosol generating article has been inserted into the receiving portion.

9. The heater assembly of claim 8, further comprising a tube arranged to surround the first sensor and the receiving portion and configured to press the first sensor in a direction toward the receiving portion to fix the first sensor.

10. The heater assembly of claim 8, further comprising a second sensor arranged between the second bracket and the cover housing and configured to detect a change in an inductance value around the heater assembly.

11. The heater assembly of claim 10, wherein the second sensor is connected to one end of the first sensor and is formed integrally with the first sensor.

12. The heater assembly of claim 1, wherein the cover housing comprises a coupling hole, and the coil assembly further comprises a rib inserted into the coupling hole,
wherein the coil assembly is coupled to the cover housing when the rib is hook-coupled to the coupling hole.

13. The heater assembly of claim 12, wherein the rib is arranged to protrude from a portion of the first bracket.

14. An aerosol generating device comprising:
a heater assembly comprising a cover housing and a coil assembly inserted into the cover housing; and
a housing accommodating the heater assembly,
wherein the coil assembly comprises:
a coil configured to generate an alternating magnetic field when power is supplied;
a first bracket comprising a receiving space for accommodating the coil and supporting the coil accommodated in the receiving space;
a second bracket coupled to one end of the first bracket and supporting the coil; and
a shielding member arranged to surround side surfaces of the first bracket and the coil and configured to shield a magnetic field radiating from the coil to an outside of the heater assembly, and
the cover housing comprises:
a receiving portion into which at least a portion of an aerosol generating article is inserted; and
a susceptor arranged inside the receiving portion so as to be insertable into the aerosol generating article and configured to heat the aerosol generating article by generating heat by using an alternating magnetic field generated by the coil,
wherein the first bracket and the second bracket fix the shielding member.

15. The aerosol generating device of claim 14, wherein the housing comprises:
a first housing accommodating the heater assembly; and
a second housing detachably coupled to the first housing, the second housing comprising an insertion hole into which the aerosol generating article is insertable, and a support portion that is inserted into an interior of the receiving portion when coupled to the first housing and surrounds the aerosol generating article inserted into the receiving portion.
